(19) United States
(12) Patent Application Publication
(10) Pub. No.: US 2010/0123754 A1
(43) Pub. Date: May 20, 2010

(54) ARRAY TYPE PRINT HEAD CLEANING APPARATUS, IMAGE FORMING APPARATUS HAVING THE SAME, AND METHOD OF CLEANING ARRAY TYPE PRINT HEAD

(75) Inventors: Tae-young LEE, Suwon-si (KR); Jung-dae Heo, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/607,140

(22) Filed: Oct. 28, 2009

(30) Foreign Application Priority Data
Nov. 18, 2008 (KR) 2008-114807

(51) Int. Cl. B41J 2/165

(52) U.S. Cl. 347/32

(57) ABSTRACT

An array type print head cleaning apparatus, and a method of using same, including a cleaning carriage formed to linearly reciprocate, a cleaning unit disposed to reciprocate between a first position and a second position in the cleaning carriage in a direction transverse to a moving direction of the cleaning carriage, and a cleaning unit moving mechanism disposed in the cleaning carriage to cause the cleaning unit to reciprocate between the first position and the second position.

### CROSS-REFERENCE TO RELATED APPLICATIONS

This application claims the benefit under 35 U.S.C. §119(a) of Korean Patent Application No. 2008-114807, filed Nov. 18, 2008 in the Korean Intellectual Property Office, the disclosure of which is incorporated herein by reference in its entirety.

### BACKGROUND

1. Field of the Invention

The present general inventive concept relates to an inkjet image forming apparatus. More particularly, the present general inventive concept relates to a cleaning apparatus of an array type print head usable with an array type inkjet image forming apparatus, and a method of cleaning the same.

2. Description of the Related Art

Generally, an array head type inkjet image forming apparatus is a type of inkjet image forming apparatus which uses ink to form images, and which includes a plurality of print heads fixed and arranged according to a size of a printing medium, in a direction transverse to a transferring direction of the printing medium. The plurality of print heads used in a conventional array head type inkjet image forming apparatus may be arranged in one or two rows to print on an entire area of the printing medium in the direction transverse to the transferring direction of the printing medium. Also, the array head type inkjet image forming apparatus may be configured so that the plurality of print heads is fixed so as not to move, with the printing medium being moved instead.

In a conventional inkjet image forming apparatus spraying ink via nozzles of the print head to form images, after a printing operation is performed, ink which is not moved to the printing medium may remain on the nozzles of the print head. Therefore, when the inkjet image forming apparatus has not been used for an extended period of time, the ink remaining on the nozzles may be solidified, thus clogging the nozzles of the print head so that the printing operation cannot be normally performed. In other words, when the inkjet image forming apparatus has not been used for a period of time, the remaining ink may react with outside air so as to be solidified on the nozzles of the print head. Also, the remaining ink may be solidified with contaminants, such as dust, to clog the nozzles. When the nozzle is clogged by the solidified ink and/or contaminants, the printing operation may not be performed normally.

Therefore, in order to perform a normal printing operation, the solidified ink clogging the nozzles of the print head must be removed. A print head cleaning apparatus, such as an ultrasonic cleaning apparatus, may be used to remove the solidified ink.

### SUMMARY

The present general inventive concept provides an array type print head cleaning apparatus to clean a plurality of print heads arranged in two rows using a print head cleaning apparatus that cleans at least one print head arranged in one row, an image forming apparatus having the same, and a method of cleaning an array type print head.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing an array type print head cleaning apparatus, which may include: a cleaning carriage formed to linearly reciprocate; a cleaning unit to clean print heads and disposed to reciprocate between a first position and a second position in the cleaning carriage in a direction transverse to a moving direction of the cleaning carriage; and a cleaning unit moving mechanism disposed in the cleaning carriage to cause the cleaning unit to reciprocate between the first position and the second position.

The cleaning unit moving mechanism may include a rotation link coupled with the cleaning unit and a bar link disposed in the cleaning carriage and coupled with the rotation link, the bar link operating the rotation link so that the cleaning unit reciprocates between the first position and the second position.

The bar link may be disposed to linearly reciprocate in a direction transverse to a moving direction of the cleaning unit.

The cleaning carriage may include a guide bar guiding movement of the cleaning unit.

The rotation link may be formed substantially in a V-shape.

The rotation link may include a center portion disposed to rotate in the cleaning carriage; a first arm extending from the center portion, and coupled with the cleaning unit; and a second arm extending from the center portion, spaced apart from the first arm, and coupled with the bar link.

The second arm may include a coupling projection formed at a leading end of the second arm; and the bar link may include a coupling groove in which the coupling projection is disposed.

The rotation link may rotate in response to the bar link moving in a first direction, thereby causing the cleaning unit to move to the first position.

The rotation link may rotate in response to the bar link moving in a second direction, thereby causing the cleaning unit to move to the second position.

The cleaning unit may include an ultrasonic cleaning apparatus.

The foregoing and/or other aspects and utilities of the present general inventive concept may also be achieved by providing an image forming apparatus that may include: a main body; a print medium feeding unit disposed in the main body to feed a printing medium; an ink cartridge including a plurality of print heads arranged in a plurality of rows in a direction transverse to a transferring direction of the printing medium to spray ink; a cleaning unit disposed to move below the print heads and clean the print heads by row; a cleaning carriage configured to cause the cleaning unit to reciprocate in a direction transverse to a transferring direction of the printing medium; and a cleaning unit moving mechanism, disposed in the cleaning carriage, to cause the cleaning unit to move to a position below one row of the plurality of rows of print heads.

The cleaning unit moving mechanism may include a rotation link disposed in the cleaning carriage and coupled with the cleaning unit and a bar link disposed in the cleaning carriage to move parallel to a moving direction of the cleaning carriage, coupled with the rotation link, and including opposite ends thereof formed to project from the cleaning carriage, wherein the rotation link is rotated to move the cleaning unit in response to the bar link moving.

The cleaning unit may be moved to a position below a first row of the plurality of print heads in response to a first end of the bar link being affected by the main body, and the cleaning unit may be moved to a position below a second row of the plurality of print heads in response to a second end of the bar link being affected by the main body.

The foregoing and/or other aspects and utilities of the present general inventive concept may also be achieved by providing a method of cleaning an array type print head that may including cleaning a first row of print heads while causing a cleaning unit to move in a first direction transverse to a transferring direction of a printing medium; operating a cleaning unit moving mechanism to cause the cleaning unit to be moved to a position below a second row of the print heads cleaning the second row of the print heads while causing the cleaning unit to move in a second direction transverse to the transferring direction of the printing medium and operating the cleaning unit moving mechanism to cause the cleaning unit to be moved to a position below the first row of the print heads.

The operation of the cleaning unit moving mechanism to cause the cleaning unit to be moved to the position below the second row of the print heads may include: causing a first end of a bar link of the cleaning unit moving mechanism to contact a main body; causing the bar link to move in the second direction relative to the cleaning unit; causing the rotation link to be rotated by the bar link; and causing the cleaning unit to be moved to the position below the second row of the print heads by the rotation link.

The operation of the cleaning unit moving mechanism to cause the cleaning unit to be moved to the position below the first row of the print heads may include: causing a second end of a bar link of the cleaning unit moving mechanism to contact a main body; causing the bar link to move in the first direction relative to the cleaning unit; causing a rotation link to be rotated by the bar link; and causing the cleaning unit to be moved to the position below the first row of the print heads by the rotation link.

The foregoing and/or other aspects and utilities of the present general inventive concept may also be achieved by providing an array type print head cleaning apparatus that may include a linearly reciprocating cleaning carriage and a cleaning unit provided in the cleaning carriage to linearly reciprocate in a direction substantially transverse to that of the cleaning carriage.

The array type print head may include a cleaning unit moving mechanism provided in the cleaning carriage to move the cleaning unit between a first position a second position according to a mechanical interaction with a structure of an image forming apparatus.

The first position may be below a first row of print heads and the second position may be below a second row of print heads.

The cleaning unit moving mechanism may include a reciprocating member to move in a direction parallel to that of the cleaning carriage.

The reciprocating member may be configured to extend from either end of the cleaning carriage, and the mechanical interaction may include contact between the structure of the image forming apparatus and the reciprocating member extending from the cleaning carriage.

The contact may stop movement of the reciprocating member during movement of the cleaning carriage, causing a coupling link coupled to the reciprocating member and the cleaning unit to move the cleaning unit.

The cleaning unit may clean a first row of print heads during movement of the cleaning carriage in a first direction, and clean a second row of print heads during movement of the cleaning carriage in a second direction.

The foregoing and/or other aspects and utilities of the present general inventive concept may also be achieved by providing a method of cleaning an array type print head that may include moving a cleaning unit in a first direction to clean a first row of print heads; and moving the cleaning unit in a second direction to clean a second row of print heads.

The cleaning unit may be disposed inside a linearly reciprocating carriage, and the cleaning unit may linearly reciprocate inside the carriage in a direction transverse to that of the carriage.

The foregoing and/or other aspects and utilities of the present general inventive concept may also be achieved by providing an array type print head cleaning apparatus that may include a cleaning unit that moves in a first direction to clean a first row of print heads, and moves in a second direction to clean a second row of print heads.

Other advantages and salient features of the present general inventive concept will become apparent from the following detailed description, which, taken in conjunction with the annexed drawings, discloses preferred embodiments of the present general inventive concept.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 is a perspective view illustrating an image forming apparatus including an array type print head cleaning apparatus according to an embodiment of the present general inventive concept;

FIG. 2 is a plan view illustrating an array type print head cleaning apparatus according to an embodiment of the present general inventive concept;

FIG. 3 is a partial perspective view illustrating an array type print head cleaning apparatus according to an embodiment of the present general inventive concept;

FIG. 4 is a partial plan view illustrating an array type print head cleaning apparatus according to an embodiment of the present general inventive concept in which a cleaning unit is located at a first position;

FIG. 5 is a partial side view illustrating the array type print head cleaning apparatus of FIG. 4;

FIG. 6 is a partial plan view illustrating an array type print head cleaning apparatus according to an embodiment of the present general inventive concept in which a cleaning unit is located at a second position;

FIG. 7 is a partial side view illustrating the array type print head cleaning apparatus of FIG. 6;

FIG. 8 is a plan view illustrating an array type print head cleaning apparatus according to an embodiment of the present general inventive concept in which a cleaning carriage approaches a second sidewall of a main body;

FIG. 9 is a plan view illustrating an array type print head cleaning apparatus according to an embodiment of the present general inventive concept in which a cleaning carriage approaches a first sidewall of a main body; and

FIG. 10 is a flowchart illustrating a method of cleaning an array type print head according to an embodiment of the present general inventive.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Various matters discussed in this description, such as a detailed construction and elements thereof, are provided merely to assist in a comprehensive understanding of the present general inventive concept. Thus, it is therefore apparent that the present general inventive concept may be carried out without those discussed matters. Also, well-known functions or constructions are omitted in order to provide a clear and concise description of exemplary embodiments of the present general inventive concept.

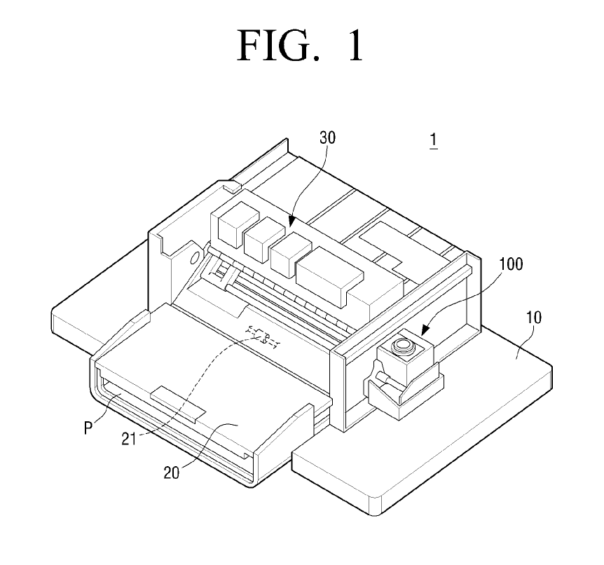

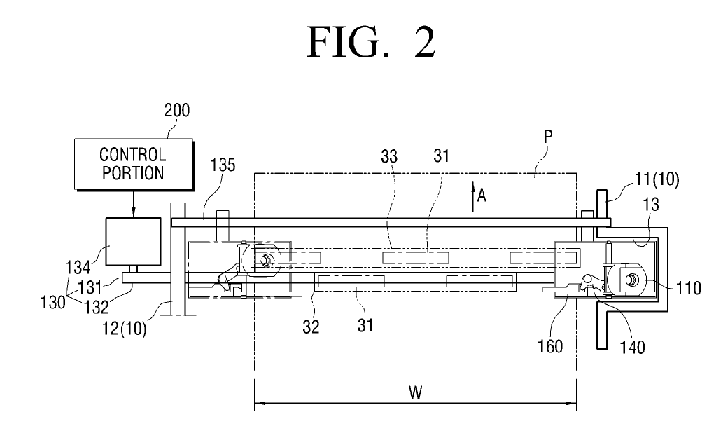

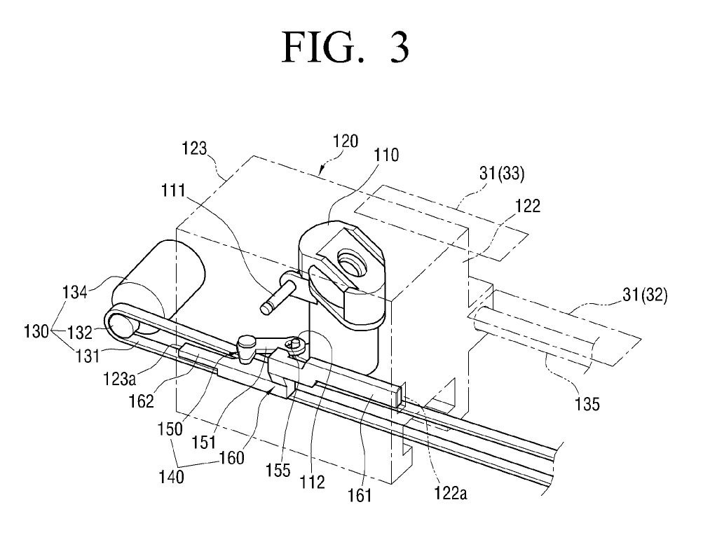

FIG. 1 is a perspective view illustrating an image forming apparatus 1 including an array type print head cleaning apparatus 100 according to an embodiment of the present general inventive concept. FIG. 2 is a plan view illustrating the array type print head cleaning apparatus 100 according to an embodiment of the present general inventive concept. FIG. 3 is a partial perspective view illustrating the array type print head cleaning apparatus 100 according to an embodiment of the present general inventive concept.

Referring to FIGS. 1 to 3, the image forming apparatus 1 according to an embodiment of the present general inventive concept may include a main body 10, a printing medium feeding unit 20, an ink cartridge 30, the array type print head cleaning apparatus 100, and a control portion 200.

The main body 10 forms much of an outer appearance of the image forming apparatus 1, and supports the printing medium feeding unit 20, the ink cartridge 30, the array type print head cleaning apparatus 100, and the control portion 200.

The printing medium feeding unit 20 may store, for example, predetermined sheets of printing media P, and may pick up the sheets of the printing medium P one by one according to a signal from the control portion 200. The picked up printing medium P may be transferred, as in this illustrated example, below the ink cartridge 30 by a transferring member such as a transferring roller 21.

The ink cartridge 30 may form images on the printing medium P according to a signal from the control portion 200, and may have a plurality of print heads 31. The plurality of print heads 31 may be arranged in a direction transverse to a transferring direction of the printing medium (arrow A in FIG. 2). Also, the plurality of print heads 31 may be arranged in one row, or in two rows or more, to print on the entire width of the printing medium P (said width indicated by dimension W in FIG. 2) in a direction transverse to the transferring direction of the printing medium P. In the present embodiment, the plurality of print heads 31 are arranged in two rows. Hereinafter, the row of the print heads 31 positioned upstream of the transferring direction of the printing medium P (lower side in FIG. 2) is referred as to a first row 32 of print heads 31, and the row of the print heads 31 positioned downstream of the transferring direction of the printing medium P (upper side in FIG. 2) is referred as to a second row 33 of print heads 31.

In the bottom surface of each of the print heads 31 is formed a plurality of nozzles to spray ink onto the printing medium P. Structure and operation of the print heads 31 having the plurality of nozzles may be the same or similar to the conventional print head; therefore, detailed explanations thereof will be omitted.

The array type print head cleaning apparatus 100 may clean ink and/or contaminants remaining on the bottom surface of the plurality of print heads 31 of the ink cartridge 30 according to a signal from the control portion 200, and may include a cleaning unit 110, a cleaning carriage 120, and a cleaning unit moving mechanism 140.

The cleaning unit 110 may be provided below the print heads 31 of the ink cartridge 30, and may clean the print heads 31. The cleaning unit 110 may be formed to clean only one of the rows of print heads 32 or 33 among the print heads 31 arranged in the two or more rows 32 and 33. In other words, while the cleaning unit 110 is moved by the cleaning carriage 120, the cleaning unit 110 may clean only one of the rows of print heads 32 or 33 selected between the first row of print heads 32 and the second row of print heads 33.

If the cleaning unit 110 is formed to clean only one of the rows of print heads 32 or 33, the size of the cleaning unit 110 may be smaller than that of the cleaning unit 110 formed to clean both of the two rows of print heads 32 and 33 at the same time. The cleaning unit 110 may comprise various cleaning apparatuses as long as the cleaning apparatuses can clean the print heads 31. In the present embodiment, an ultrasonic cleaning apparatus, which can dissolve and remove ink and/or contaminants solidified on the nozzles of the print heads 31, may be used as the cleaning unit 110. The ultrasonic cleaning apparatus uses ultrasonic waves to atomize a cleaning solution and spray the atomized cleaning solution onto the print heads 31.

The cleaning carriage 120 may carry the cleaning unit 110 along the plurality of print heads 31, and may be formed to linearly move in the direction transverse to the transferring direction of the printing medium P. The cleaning carriage 120 may be formed substantially in a rectangular enclosure. The cleaning unit 110 may be disposed inside the cleaning carriage 120, and may be formed to linearly move along a guide bar 111 disposed in the cleaning carriage 120. The guide bar 111 may be disposed in a direction transverse to a moving direction of the cleaning carriage 120, that is, parallel to the transferring direction of the printing medium P. Therefore, the cleaning unit 110 may move between a first position and a second position inside the cleaning carriage 120 in the direction transverse to the moving direction of the cleaning carriage 120. Here, the first position indicates a position at which the cleaning unit 110 can clean the first row of the print heads 32 located upstream of the transferring direction of the printing medium P, and the second position indicates a position at which the cleaning unit 110 can clean the second row of the print heads 33 located downstream of the transferring direction of the printing medium P.

Also, the cleaning carriage 120 may include a carriage driving unit 130. The carriage driving unit 130 may cause the cleaning carriage 120 to move, and may include a belt 131, driving pulley 132 and driven pulley (not illustrated, and may simply support the belt 131 at one non-driving, hence driven, end as a substantial mirror image of the driving pulley 132), and a driving motor 134 to rotate the driving pulley 132. The driving pulley 132 and driven pulley support the belt 131 and cause the belt 131 to move, for example, in a reciprocating motion.

The cleaning carriage 120 may be fixed to the belt 131. Therefore, while the belt 131 is moved by the driving pulley 132, the cleaning carriage 120 also moves correspondingly with the belt 131. A timing belt may be used as the belt 131. Also, as illustrated in FIGS. 2 and 3, a carriage shaft 135, to which the cleaning carriage 120 may be movingly coupled, may be disposed in close proximity to the belt 131 so that the cleaning carriage 120 stably moves with the belt 131. The carriage shaft 135 may be supported by a first sidewall 11 and a second sidewall 12 of the main body 10.

The cleaning unit moving mechanism 140 may be disposed in the cleaning carriage 120, and may cause the cleaning unit 110 to move such that the cleaning unit 110 may be located at either of the first position and the second position. The cleaning unit moving mechanism 140 may include a rotation link 150 and a bar link 160.

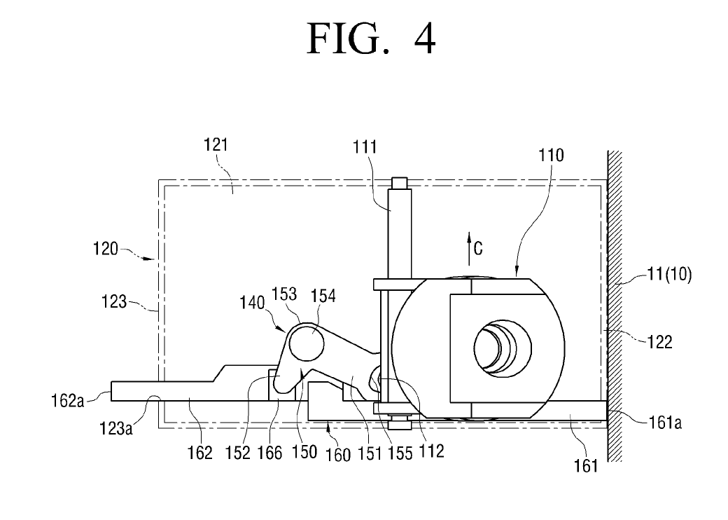

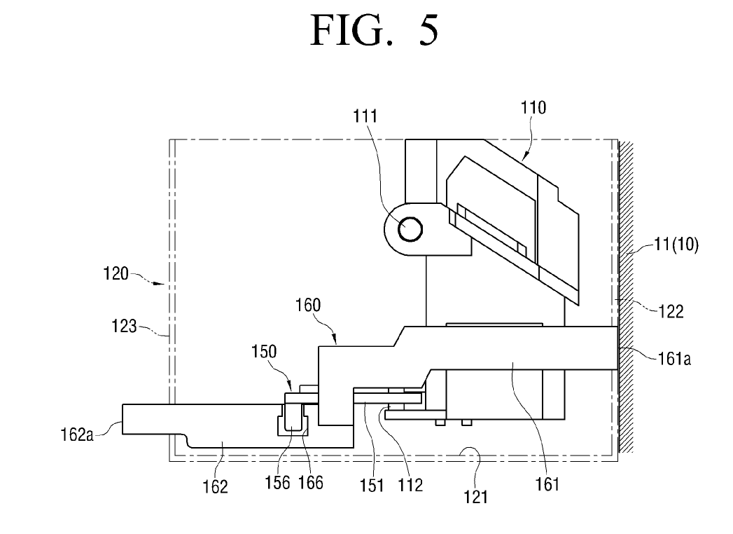

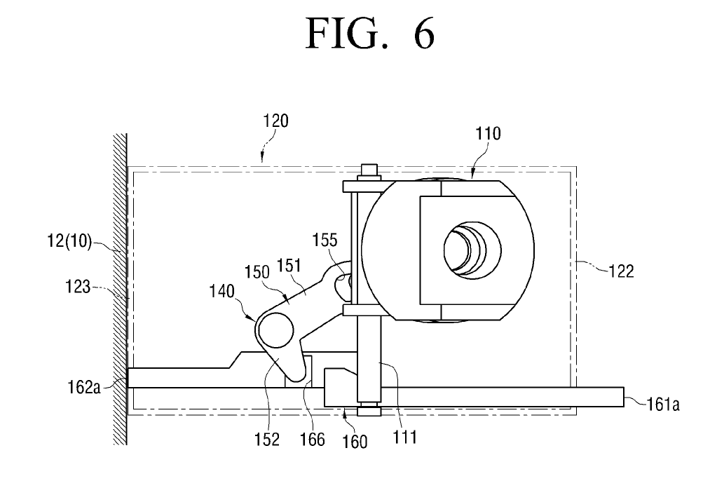

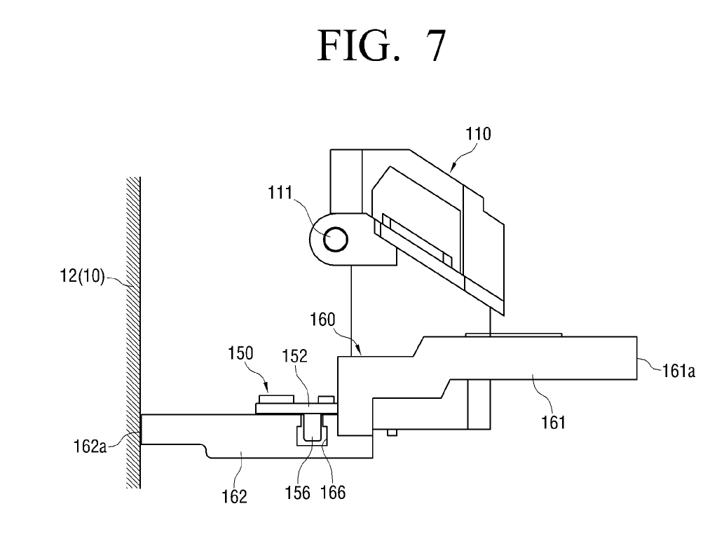

FIG. 4 is a partial plan view illustrating an array type print head cleaning apparatus according to an embodiment of the present general inventive concept in which a cleaning unit is located at the first position. FIG. 5 is a partial side view illustrating the array type print head cleaning apparatus of FIG. 4. FIG. 6 is a partial plan view illustrating an array type print head cleaning apparatus according to an embodiment of the present general inventive concept in which the cleaning unit is located at the second position. FIG. 7 is a partial side view illustrating the array type print head cleaning apparatus of FIG. 6.

The rotation link 150 may be disposed in the proximity of the bottom surface 121 of the cleaning carriage 120. One end of the rotation link 150 may be coupled with the cleaning unit 110, and the other end of the rotation link 150 may be coupled with the bar link 160. The rotation link 150 may be formed substantially in a V-shape. More particularly, the rotation link 150, as illustrated in FIG. 4, may include a center portion 153 rotatably disposed near the bottom surface 121 of the cleaning carriage 120, a first arm 151 that extends from the center portion 153 and is coupled with the cleaning unit 110, and a second arm 152 that extends from the center portion 153, is spaced apart by a predetermined angle from the first arm 151, and is coupled with the bar link 160. The center portion 153 of the rotation link 150 may be rotatably supported by a rotation shaft 154 disposed near the bottom surface 121 of the cleaning carriage 120. A stud may be used as the rotation shaft 154. Also, the angle between the first arm 151 and the second arm 152 of the rotation link 150 may be determined so that movement of the bar link 160 causes the cleaning unit 110 to move from the first position to the second position. A coupling hole 155 may be formed in a leading end of the first arm 151 of the rotation link 150. A coupling bar 112 inserted in the coupling hole 155 of the rotation link 150 may be disposed at the bottom of the cleaning unit 110. The coupling hole 155 of the rotation link 150 may have a cross sectional area larger than that of the coupling bar 112 of the cleaning unit 110. Also, a coupling projection 156 may be formed at a leading end of the second arm 152 of the rotation link 150. The bar link 160 may have a coupling groove 166 in which the coupling projection 156 is inserted.

The bar link 160 may operate the rotation link 150 so that the cleaning unit 110 is located at either of the first position and the second position, and may be disposed in the cleaning carriage 120 to move parallel to the moving direction of the cleaning carriage 120. That is, the bar link 160 may be disposed in the cleaning carriage 120 and may linearly reciprocate in a direction transverse to a direction in which the cleaning unit 110 moves inside the cleaning carriage 120. In the present general inventive concept, the bar link 160, as illustrated in FIG. 3, is disposed at a side surface of the cleaning carriage 120 to perform a slidable movement with respect to the cleaning carriage 120. Bar holes 122a and 123a, from which opposite ends 161a and 162a of the bar link 160 may respectively project, may be formed at a front surface 122 and a rear surface 123 of the cleaning carriage 120, respectively. As a result, according to the moving direction of the cleaning carriage 120, one of the opposite ends 161a and 162a of the bar link 160 may project from the cleaning carriage 120. Therefore, as illustrated in FIG. 4, when a first end 161a of the bar link 160 is affected by the first sidewall 11 of the main body 10, such as the first end 161a being prevented from projecting through the bar hole 122a due to interference from the first sidewall 11, a second end 162a of the bar link 160 may be projected from the rear surface 123 of the cleaning carriage 120 through the bar hole 123a. When the second end 162a of the bar link 160, as illustrated in FIG. 6, is similarly affected by the second sidewall 12 of the main body 10, the first end 161a of the bar link 160 is projected from the front surface 122 of the cleaning carriage 120 through the bar hole 122a.

Also, the coupling projection 156 of the second arm 152 of the rotation link 150 may be inserted in the coupling groove 166 of the bar link 160 so that the bar link 160 and the rotation link 150 are coupled with each other. Therefore, while the bar link 160 moves along the sidewall of the cleaning carriage 120, the rotation link 150 rotates about the center portion 153 supported by the rotation shaft 154 due to being coupled to both the bar link 160 and the cleaning unit 110, the cleaning unit 110 being fixed to the cleaning carriage 120 in the direction transverse to the transferring direction of the printing medium. The bar link 160 may be formed so as not to interfere with the rotation link 150. In the present embodiment, to prevent interference with the rotation link 150, as illustrated in FIG. 5, the bar link 160 is formed so that a first portion 161 of the bar link 160 is spaced apart from a second portion 162 of the bar link 160 in a vertical direction with respect to the bottom surface 121 of the cleaning carriage 120. The bar link 160 is further formed, as illustrated in FIG. 4, so that the first portion 161 of the bar link 160 is spaced apart from the second portion 162 of the bar link 160 in the moving direction (arrow C) of the cleaning unit 110.

The control portion 200 may control the driving motor 134 of the carriage driving unit 130 to move the cleaning carriage 120, and may control the cleaning unit 110 to spray cleaning solution onto the print heads 31. In other words, the control portion 200 may control rotational speed and rotation direction of the driving motor 134 so that the cleaning unit 110 cleans the plurality of print heads 31 of the ink cartridge 30. The control portion 200 may control the image forming apparatus 1 to form predetermined images on a printing medium P. The process in which the control portion 200 controls the image forming apparatus 1 to form images may be the same or similar to the control portion of the conventional image forming apparatus. Therefore, a detailed description thereof is omitted.

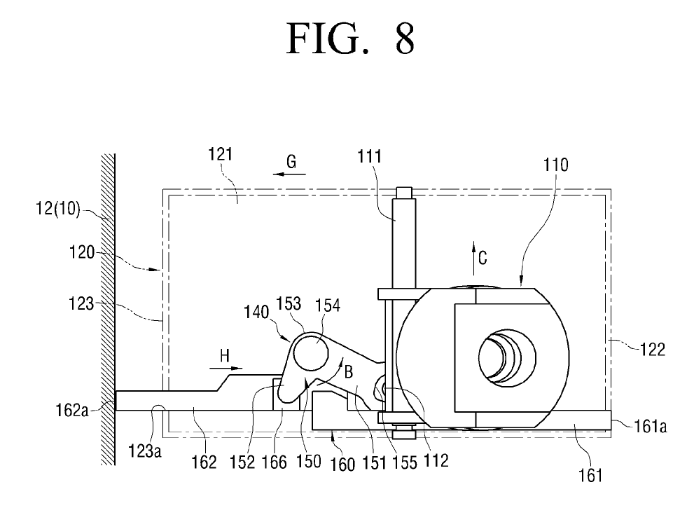

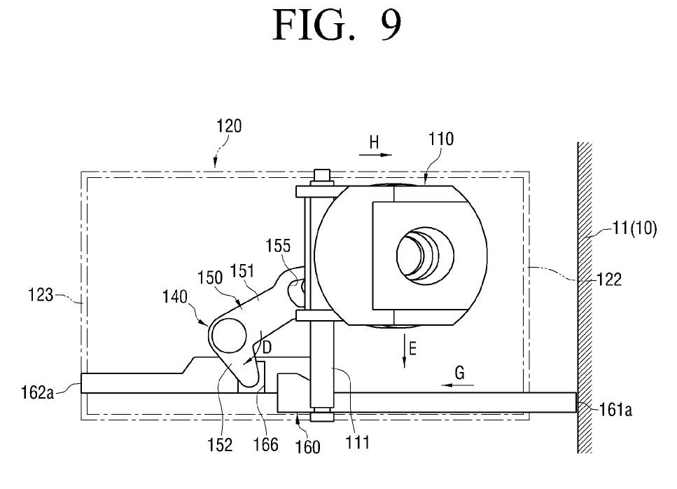

Hereinafter, operation of the image forming apparatus 1 having the array type print head cleaning apparatus 100 according to an embodiment of the present general inventive concept will be explained with reference to the accompanying drawings. FIG. 8 is a plan view illustrating an array type print head cleaning apparatus according to an embodiment of the present general inventive concept in which a cleaning carriage approaches a second sidewall of a main body. FIG. 9 is a plan view illustrating an array type print head cleaning apparatus according to an embodiment of the present general inventive concept in which a cleaning carriage approaches a first sidewall of a main body.

When standing by for a printing operation, the cleaning carriage 120 of the array type print head cleaning apparatus 100 may be located at a home position 13 provided in the first sidewall 11 of the main body 10. The plurality of print heads 31 of the ink cartridge 30 may be covered by a capping module (not illustrated). Therefore, the plurality of print heads 31 may be protected in an airtight state. When the printing operation starts, the capping module covering the print heads 31 moves to expose the nozzles of the print heads 31.

After receiving a printing command, the control portion 200 performs a print preparing process. That is, the control portion 200 causes the capping module to move so that the nozzles of the print heads 31 are exposed. After the nozzles are exposed, the control portion 200 performs a spitting process to spray a small amount of ink via the nozzles. Then the wiping unit (not illustrated) performs a wiping operation with respect to the bottom surface of the print heads 31 in which the nozzles are formed. After the print preparing process finishes, a platen (not illustrated) moves near and below the plurality of print heads 31, and sets in a position close to the bottom surface of the print heads 31.

After that, the control portion 200 controls the printing medium feeding unit 20 to pick up a printing medium P and to transfer the printing medium P to a space between the plurality of print heads 31 and the platen. The nozzles of the print heads 31 spray ink to form predetermined images on the transferred printing medium P.

After the printing operation is finished, the control portion 200 causes the platen to move, thereby forming an empty space below the plurality of print heads 31. Then, the wiping unit may be located below the plurality of print heads 31 to wipe the bottom surface of the plurality of print heads 31. After the wiping operation is finished, the wiping unit may move out of the space below the print heads 31, and the capping module may cover the bottom surface of the plurality of print heads 31 to prevent the nozzles from being exposed to air.

When the image forming apparatus 1 performs such a printing operation, some nozzles of the plurality of print heads 31 may be clogged with the previously discussed ink and/or contaminants. Ink which is not moved to the printing medium, and which remains on the nozzles of the print heads 31, may react with air. The ink remaining on the nozzles may be solidified, or contaminants such as dust in the air may be solidified along with the ink so as to clog the nozzles of the print heads 31. When the nozzles are clogged, the control portion 200 may use the array type print head cleaning apparatus 100 to perform a print heads cleaning process to remove the solidified ink or contaminants clogging the nozzles of the plurality of print heads 31. When the ultrasonic cleaning apparatus is used as the cleaning unit 110, the cleaning solution is atomized by the ultrasonic wave and is sprayed onto the print heads 31. The sprayed cleaning solution dissolves the ink or contaminants solidified on the nozzles of the print heads 31.

When a cleaning sensor (not illustrated) detects that the nozzles of the print heads 31 are clogged, the print head cleaning process may be started. Alternatively, a user may initiate the print head cleaning process. Alternatively, the control portion 200 of the image forming apparatus 1 may automatically start the print head cleaning process according to a specific standard, such as the number of pages that have been printed, a predetermined time that has passed, etc.

When the print head cleaning process starts, the control portion 200 may cause the capping module to cap the print heads 31 of the ink cartridge 30, or the platen positioned near the print heads 31 for printing to move, thereby forming a space in which the cleaning carriage 120 can move below the plurality of print heads 31.

After the space is formed below the plurality of print heads 31, the control portion 200 controls the driving motor 134 so that the cleaning carriage 120 moves from the home position 13 to the space below the plurality of print heads 31. When a motor shaft of the driving motor 134 rotates, the belt 131 is rotated by the driving pulley 132 so that the cleaning carriage 120 moves below the plurality of print heads 31. When the cleaning carriage 120 is located at the home position 13 of the first sidewall 11, the cleaning unit 110, as illustrated in FIGS. 2 and 4, is located at the first position, that is, a position in which the cleaning unit 110 can clean the first row of the print heads 32. As a result, while the cleaning carriage 120 moves from the home position 13, the cleaning unit 110 cleans the first row of the print heads 32.

When the cleaning carriage 120 approaches the second sidewall 12 of the main body 10, as illustrated in FIG. 8, the second end 162a of the bar link 160 projecting from the rear surface 123 of the cleaning carriage 120 first contacts the second sidewall 12 of the main body 10. In this state, when the motor shaft of the driving motor 134 continues to rotate in the same direction, the bar link 160 maintains a stationary state and only the cleaning carriage 120 moves to the second sidewall 12 until the rear surface 123 of the cleaning carriage 120, as illustrated in FIG. 6, contacts or is located near the second sidewall 12. In other words, while the bar link 160 is in a stationary state due to the contact with the second sidewall 12, the cleaning carriage 120 continues to move in the same direction at least momentarily. As a result, the second end 162a of the bar link 160 is forced inside of the cleaning carriage 120 through the bar hole 123a, and the first end 161a of the bar link 160 is forced to project from the front surface 122 of the cleaning carriage 120 through the bar hole 122a. Thus, relative to the cleaning carriage 120, the bar link 160 is displaced linearly toward the first sidewall 11 of the main body 10 (a second direction, arrow H) in a direction parallel to the moving direction of the cleaning carriage 120.

While the bar link 160 is relatively displaced linearly in the second direction with respect to the cleaning carriage 120, the rotation link 150 coupled with the bar link 160 is rotated in the counterclockwise direction (arrow B in FIG. 8) about a point supported by the rotation shaft 154. That is, when the bar link 160 is linearly displaced in the second direction relative to the cleaning carriage 120, the coupling projection 156 of the second arm 152 of the rotation link 150 inserted in the coupling groove 166 of the bar link 160 is relatively displaced together with the bar link 160. Accordingly, the rotation link 150 is rotated in the counterclockwise direction (arrow B) about the rotation shaft 154. When the rotation link 150 rotates in the counterclockwise direction, the cleaning unit 110 coupled with the first arm 151 of the rotation link 150 is moved along the guide bar 111 in a direction of arrow C as illustrated in FIG. 8, and is relocated to the second position as illustrated in FIG. 6.

When the cleaning carriage 120 arrives at the second sidewall 12 of the main body 10, the control portion 200 causes the motor shaft of the driving motor 134 to rotate in reverse so that the cleaning carriage 120 is moved back in the direction of the home position 13 of the first sidewall 11 of the main body 10. At this time, since the cleaning unit 110 disposed in the cleaning carriage 120 is located at the second position, while the cleaning carriage 120 is returned to the home position 13, the cleaning unit 110 cleans the second row of the print heads 33. The control portion 200 may determine when to change the rotation direction of the motor shaft of the driving motor 134 by using, for example, a position sensor (not illustrated) sensing the position of the cleaning carriage 120. Alternatively, the control portion 200 may use the moving speed and moving distance of the cleaning carriage 120 to determine when to change the rotation direction of the motor shaft of the driving motor 134.

When the cleaning carriage 120 approaches the first sidewall 11 of the main body 10, as illustrated in FIG. 9, the first end 161a of the bar link 160 projecting from the front surface 122 of the cleaning carriage 120 first contacts the first sidewall 11 of the main body 10. In this state, when the motor shaft of the driving motor 134 continues to rotate in the same direction, the bar link 160 maintains a stationary state and only the cleaning carriage 120 moves to the first sidewall 11 of the main body 10 so that the front surface 122 of the cleaning carriage 120, as illustrated in FIG. 4, contacts or is located near the first sidewall 11. Then, the first end 161a of the bar link 160 is forced inside of the cleaning carriage 120 through the bar hole 122a, and the second end 162a of the bar link 160 is forced to project from the rear surface 123 of the cleaning carriage 120 through the bar hold 123a. Thus, relative to the cleaning carriage 120, the bar link 160 linearly moves toward the second sidewall 12 of the main body 10 (a first direction, arrow G) in a direction parallel to the moving direction of the cleaning carriage 120.

While the bar link 160 is relatively displaced linearly in the first direction with respect to the cleaning carriage 120, the rotation link 150 coupled with the bar link 160 is rotated in the clockwise direction (arrow D in FIG. 9) about the rotation shaft 154. That is, when the bar link 160 is linearly displaced in the first direction relative to the cleaning carriage 120, the coupling projection 156 of the second arm 152 of the rotation link 150 inserted in the coupling groove 166 of the bar link 160 is relatively displaced together with the bar link 160. Accordingly, the rotation link 150 is rotated in the clockwise direction (arrow D) about the rotation shaft 154. When the rotation link 150 rotates in the clockwise direction, the cleaning unit 110 coupled with the first arm 151 of the rotation link 150 is moved along the guide bar 111 in a direction of arrow E as illustrated in FIG. 9, and is relocated to the first position as illustrated in FIG. 4.

When the cleaning carriage 120 arrives at the home position 13, the control portion 200 may control the wiping unit to wipe the bottom surface of the plurality of print heads 31 in which the plurality of nozzles are formed. At this time, because the ink and/or contaminants solidified on the bottom surface of the plurality of print heads 31 are dissolved by the cleaning solution, they are easily removed from the print heads 31 by the wiping operation of the wiping unit.

After the wiping operation is completed, the control portion 200 may cause the capping module to cover the print heads 31, thereby preventing the nozzles from contacting air and/or contaminants.

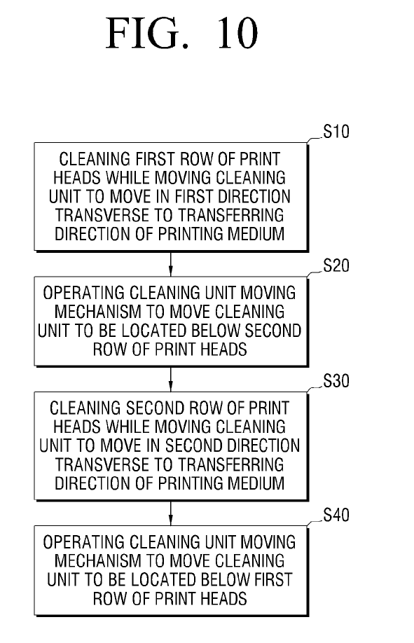

Hereinafter, a method of cleaning the array type print head according to an embodiment of the present general inventive concept usable with an image forming apparatus 1 having the array type print head cleaning apparatus 100 will be explained with reference to accompanying FIGS. 2 and 10. FIG. 10 is a flowchart illustrating a method of cleaning an array type print head according to an embodiment of the present general inventive.

In the image forming apparatus 1 having the plurality of print heads 31 arranged in two rows, the control portion 200 controls the cleaning carriage 120 so that the cleaning unit 110 moves in the direction from the home position 13 to the second sidewall 12 of the main body 10 of the image forming apparatus 1, this direction being transverse to the transferring direction of the printing medium P (the first direction, arrow G in FIG. 9). Concurrently, the control portion 200 controls the cleaning unit 110 to clean the first row of the print heads 32 (S10).

When the cleaning carriage 120 approaches the second sidewall 12 of the main body 10, the cleaning unit moving mechanism 140 is operated so that the cleaning unit 110 moves from below the first row of the print heads 32 to below the second row of the print heads 33 (S20).

The process in which the cleaning unit moving mechanism 140 causes the cleaning unit 110 to move is explained in detail hereinafter. When the cleaning carriage 120 approaches the second sidewall 12 of the main body 10, the second end 162a of the bar link 160 of the cleaning unit moving mechanism 140 contacts the second sidewall 12 of the main body 10. After the second end 162a of the bar link 160 contacts the second sidewall 12 of the main body 10, the bar link 160 is prevented from moving further, that is, the bar link 160 maintains a stationary state and the cleaning carriage 120 continues to move in the first direction (arrow G). By considering the cleaning carriage 120 to be in the stationary state, the bar link 160 moves, relative to the cleaning carriage 120, in the direction of the first sidewall 11 of the main body 10 (the second direction). During this relative movement of the bar link 160 in the second direction (arrow H), that is, when the bar link 160 is in a stationary state and only the cleaning carriage 120 moves to the first direction, the rotation link 150 is rotated in the counterclockwise direction (arrow B) by the bar link 160. When the rotation link 150 is rotated in the counterclockwise direction, the cleaning unit 110 is moved from a position below the first row of the print heads 32 to a position below the second row of the print heads 33. At this time, the guide bar 111 guides the cleaning unit 110 to move from below the first row of the print heads 32 to below the second row of the print heads 33.

When the cleaning unit 110 has moved from below the first row of the print heads 32 to below the second row of the print heads 33, the control portion 200 controls the cleaning carriage 120 to move in reverse. In other words, the control portion 200 controls the cleaning unit 110 to move in the second direction (arrow H) transverse to the transferring direction of the printing medium P, and to clean the second row of the print heads 33 (S30).

When the cleaning carriage 120 approaches the first sidewall 11 of the main body 10, that is, when the cleaning carriage 120 is approaching at the home position 13, the cleaning unit moving mechanism 140 is operated so that the cleaning unit 110 moves from below the second row of the print heads 33 to below the first row of the print heads 32 (S40).

The process in which the cleaning unit 110 is moved by the cleaning unit moving mechanism 140 will be explained in detail as below. When the cleaning carriage 120 approaches the first sidewall 11 of the main body 10, the first end 161a of the bar link 160 of the cleaning unit moving mechanism 140 contacts the first sidewall 11 of the main body 10. After the first end 161a of the bar link 160 contacts the first sidewall 11 of the main body 10, the bar link 160 cannot move further, that is, the bar link 160 maintains in a stationary state and the cleaning carriage 120 continues to move in the second direction (arrow H). By considering the cleaning carriage 120 to be in the stationary state, the bar link 160 moves, relative to the cleaning carriage 120, in the direction of the second sidewall 12 of the main body 10 (the first direction). During this relative movement of the bar link 160 in the first direction (arrow G), that is, when the bar link 160 is in a stationary state and only the cleaning carriage 120 moves in the second direction (arrow H), the rotation link 150 is rotated in the clockwise direction (arrow D) by the bar link 160. When the rotation link 150 is rotated in the clockwise direction, the cleaning unit 110 is moved from below the second row of the print heads 33 to below the first row of the print heads 32.

After the cleaning carriage 120 returns to the home position 13, the control portion 200 controls the wiping unit (not illustrated) to wipe the bottom surface of the print heads 31.

An array type print head cleaning apparatus according to an embodiment of the present general inventive concept, an image forming apparatus having the same, and a method of cleaning the array type print head as described above may be formed to cause a cleaning unit, which is typically capable of cleaning one row of print heads, to clean two rows of print heads. Therefore, manufacturing cost and size of the cleaning unit may be reduced.

While the embodiments of the present general inventive concept have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the general inventive concept.

What is claimed is:

1. An array type print head cleaning apparatus comprising:
a cleaning carriage formed to linearly reciprocate;
a cleaning unit to clean print heads and disposed to reciprocate between a first position and a second position in the cleaning carriage in a direction transverse to a moving direction of the cleaning carriage; and
a cleaning unit moving mechanism disposed in the cleaning carriage to cause the cleaning unit to reciprocate between the first position and the second position.

2. The array type print head cleaning apparatus of claim 1, wherein the cleaning unit moving mechanism comprises:
a rotation link coupled with the cleaning unit; and
a bar link disposed in the cleaning carriage and coupled with the rotation link, the bar link operating the rotation link so that the cleaning unit reciprocates between the first position and the second position.

3. The array type print head cleaning apparatus of claim 2, wherein the bar link is disposed to linearly reciprocate in a direction transverse to a moving direction of the cleaning unit.

4. The array type print head cleaning apparatus of claim 2, wherein the cleaning carriage comprises a guide bar guiding movement of the cleaning unit.

5. The array type print head cleaning apparatus of claim 2, wherein the rotation link is formed substantially in a V-shape.

6. The array type print head cleaning apparatus of claim 5, wherein the rotation link comprises:
a center portion disposed to rotate in the cleaning carriage;
a first arm extending from the center portion, and coupled with the cleaning unit; and
a second arm extending from the center portion, spaced apart from the first arm, and coupled with the bar link.

7. The array type print head cleaning apparatus of claim 6, wherein the second arm comprises:
a coupling projection formed at a leading end of the second arm; and
the bar link comprises a coupling groove in which the coupling projection is disposed.

8. The array type print head cleaning apparatus of claim 6, wherein the rotation link rotates in response to the bar link moving in a first direction, thereby causing the cleaning unit to move to the first position.

9. The array type print head cleaning apparatus of claim 6, wherein the rotation link rotates in response to the bar link moving in a second direction, thereby causing the cleaning unit to move to the second position.

10. The array type print head cleaning apparatus of claim 1, wherein the cleaning unit comprises an ultrasonic cleaning apparatus.

11. An image forming apparatus, comprising:
a main body;
a print medium feeding unit disposed in the main body to feed a printing medium;
an ink cartridge including a plurality of print heads arranged in a plurality of rows in a direction transverse to a transferring direction of the printing medium to spray ink;
a cleaning unit disposed to move below the print heads and to clean the print heads by row;
a cleaning carriage configured to cause the cleaning unit to reciprocate in a direction transverse to a transferring direction of the printing medium; and
a cleaning unit moving mechanism disposed in the cleaning carriage to cause the cleaning unit to move to a position below one row of the plurality of rows of print heads.

12. The image forming apparatus of claim 11, wherein the cleaning unit moving mechanism comprises:
a rotation link disposed in the cleaning carriage and coupled with the cleaning unit; and
a bar link disposed in the cleaning carriage to move parallel to a moving direction of the cleaning carriage, coupled with the rotation link, and including opposite ends thereof formed to project from the cleaning carriage;
wherein the rotation link is rotated to move the cleaning unit in response to the bar link moving.

13. The image forming apparatus of claim 12, wherein the cleaning unit is moved to a position below a first row of the plurality of print heads in response to a first end of the bar link being affected by the main body; and
the cleaning unit is moved to a position below a second row of the plurality of print heads in response to a second end of the bar link being affected by the main body.

14. The image forming apparatus of claim 12, wherein the cleaning carriage comprises a guide bar guiding movement of the cleaning unit.

15. The image forming apparatus of claim 12, wherein the rotation link is formed substantially in a V-shape.

16. The image forming apparatus of claim 15, wherein the rotation link comprises:
a center portion disposed to rotate in the cleaning carriage;
a first arm extending from the center portion, and coupled with the cleaning unit; and
a second arm extending from the center portion, spaced apart from the first arm, and coupled with the bar link.

17. The image forming apparatus of claim 16, wherein the second arm comprises:
a coupling projection formed at a leading end of the second arm; and
the bar link comprises a coupling groove in which the coupling projection is disposed.

18. A method of cleaning an array type print head, the method comprising:
cleaning a first row of print heads while causing a cleaning unit to move in a first direction transverse to a transferring direction of a printing medium;
operating a cleaning unit moving mechanism to cause the cleaning unit to be moved to a position below a second row of the print heads;
cleaning the second row of the print heads while causing the cleaning unit to move in a second direction transverse to the transferring direction of the printing medium; and
operating the cleaning unit moving mechanism to cause the cleaning unit to be moved to a position below the first row of the print heads.

19. The method of claim 18, wherein the operation of the cleaning unit moving mechanism to cause the cleaning unit to be moved to the position below the second row of the print heads comprises:
causing a first end of a bar link of the cleaning unit moving mechanism to contact a main body;
causing the bar link to move in the second direction relative to the cleaning unit;
causing a rotation link to be rotated by the bar link; and
causing the cleaning unit to be moved to the position below the second row of the print heads by the rotation link.

20. The method of claim 18, wherein the operation of the cleaning unit moving mechanism to cause the cleaning unit to be moved to the position below the first row of the print heads comprises:
causing a second end of a bar link of the cleaning unit moving mechanism to contact a main body;
causing the bar link to move in the first direction relative to the cleaning unit;
causing a rotation link to be rotated by the bar link; and
causing the cleaning unit to be moved to the position below the first row of the print heads by the rotation link.

21. An array type print head cleaning apparatus comprising:
a linearly reciprocating cleaning carriage; and
a cleaning unit provided in the cleaning carriage to linearly reciprocate in a direction substantially transverse to that of the cleaning carriage.

22. The array type print head cleaning apparatus of claim 21, further comprising: a cleaning unit moving mechanism provided in the cleaning carriage to move the cleaning unit between a first position a second position according to a mechanical interaction with a structure of an image forming apparatus.

23. The array type print head cleaning apparatus of claim 22, wherein the first position is below a first row of print heads and the second position is below a second row of print heads.

24. The array type print head cleaning apparatus of claim 22, wherein the cleaning unit moving mechanism includes a reciprocating member to move in a direction parallel to that of the cleaning carriage.

25. The array type print head cleaning apparatus of claim 24, wherein the reciprocating member is configured to extend from either end of the cleaning carriage, and the mechanical interaction includes contact between the structure of the image forming apparatus and the reciprocating member extending from the cleaning carriage.

26. The array type print head cleaning apparatus of claim 25, wherein the contact stops movement of the reciprocating member during movement of the cleaning carriage, causing a coupling link coupled to the reciprocating member and the cleaning unit to move the cleaning unit.

27. The array type print head cleaning apparatus of claim 21, wherein the cleaning unit cleans a first row of print heads during movement of the cleaning carriage in a first direction, and cleans a second row of print heads during movement of the cleaning carriage in a second direction.

28. A method of cleaning an array type print head, the method comprising:
moving a cleaning unit in a first direction to clean a first row of print heads; and
moving the cleaning unit in a second direction to clean a second row of print heads.

29. The method of claim 28, wherein the cleaning unit is disposed inside a linearly reciprocating carriage, and the cleaning unit linearly reciprocates inside the carriage in a direction opposite to that of the carriage.

30. The method of claim 28, wherein the second direction is opposite to the first direction.

31. An array type print head cleaning apparatus comprising:
a cleaning unit that moves in a first direction to clean a first row of print heads, and moves in a second direction to clean a second row of print heads.
